(19) United States
(12) Patent Application Publication
(10) Pub. No.: US 2005/0140626 A1
(43) Pub. Date: Jun. 30, 2005

(54) Method of processing a video image sequence in a liquid crystal display panel

(76) Inventors: Didier Doyen, La Bouexiere (FR); Thierry Borel, Noyal Sur Vilaine (FR); Jonathan Kervec, Paimpont (FR); Fabienne Forlot, Massy (FR)

Correspondence Address: THOMSON LICENSING INC., PATENT OPERATIONS, PO BOX 5312, PRINCETON, NJ, 08543-5312, US

(21) Appl. No.: 10/879,659

(22) Filed: Jun. 29, 2004

(30) Foreign Application Priority Data
Jul. 1, 2003 (FR) 03/07932

(51) Int. Cl. G09G 3/36

(52) U.S. Cl. 345/89

(57) ABSTRACT

The present invention relates to a method of processing a video image sequence in a liquid crystal display panel and to a device for implementing this method. According to one embodiment of the invention, at least one motion-compensated image is generated for each group of m consecutive images of the sequence, m being greater or equal to 2, in order to obtain a group of n consecutive images, with n>m. Said group of n consecutive images replaces the group of m consecutive images into the sequence. Next, for each pixel having in a current image of the new sequence a current grey level and in the next image a different target grey level, an intercalary grey level is calculated which is higher or lower than said target grey level depending on whether said target grey level is respectively higher or lower than the current grey level of the pixel. Next, in the current image, the current grey level of the pixels is replaced with said calculated intercalary level. This method makes it possible to correct the blurring effects due to the mode of display and to the high response time of the LCD panel.

### FIELD OF THE INVENTION

The present invention relates to a method of processing a video image sequence in a liquid crystal display panel and to a device for implementing this method.

### BACKGROUND OF THE INVENTION

The technology of liquid crystals is being employed more and more in the field of computer monitors on account of the reduction in implementation costs of this technology. Recent progress in this technology suggests that, in the near future, liquid crystal television sets will replace cathode ray tube television sets. However, this technology remains penalized by the relatively long response time of liquid crystals. This does not constitute a problem in the case of a computer monitor displaying still images. The results are on the other hand appreciably worse for the displaying of moving images, for example in the field of video applications. The quality of the display is then no longer acceptable.

One of the aims of the invention is to improve the quality of display of moving images.

In liquid crystal technology, hereinbelow called LCD technology, the grey levels are obtained by applying, to the liquid crystal cell, a voltage proportional to the grey level desired for the duration of the image. When this voltage changes, the cell does not respond instantaneously. Statistically it requires a few milliseconds to modify the orientation of its liquid crystal molecules.

In the case of still images or images whose content changes with a frequency much lower than the refresh frequency of the screen, the defect engendered by this relatively long response time is not perceptible. On the other hand, in the case of moving images, for example video images, the eye detects a temporal perturbation. The mode of display consisting in displaying the grey levels throughout the duration of the frame of an image also engenders a temporal perturbation detected by the eye.

These perturbations are illustrated by FIGS. 1A to 1C which show a transition between a grey level 255 and a grey level 0 over two consecutive video frames, N and N+1. In these figures, the ordinate axis represents the time axis and the abscissa axis represents the pixels. In FIG. 1A, the transition between the two grey levels is fixed. In FIG. 1B, it moves by two pixels to the left between the two frames and in FIG. 1C it moves by two pixels to the right. The high response time of liquid crystal cells corresponding to a change in the voltage applied to the terminals of the cells prolongs their state for an extra duration beyond the video frame considered. The eye temporally integrates the grey levels, following the oblique lines represented in the figures since it tends to follow the movement of the transition. The eye then perceives a grey level such as represented by the graph at the bottom of the figures. The result of the integration is manifested by the appearance of a blurred transition between the grey levels 255 and 0. This transition exhibits a width of around 3 pixels. This defect of blurred contours is known simply as the “blurring effect”.

The defects engendered solely by the mode of display are shown in FIGS. 2A to 2C, respectively representing the transitions of FIGS. 1A to 1C without the display defect engendered by the high response time of the cells of the display panel. It is appreciated that the blurred transition engendered by the mode of display exhibits a width of around 2 pixels.

Solutions are known for separately correcting the defect engendered by the mode of display and the defect engendered by the high response time of the cells. One of the known solutions for correcting the defects engendered by the mode of display consists in increasing the display frequency of the images, also called the image frequency. It is for example possible to double the display frequency of the images by generating, for each pair of images of the sequence to be viewed, a motion-compensated intermediate image. This intermediate image is displayed between the two frames N and N+1, the duration of the frames then being divided by 2. FIGS. 3A to 3C, to be compared with FIGS. 2A to 2C, illustrate this solution. Frame N is divided into a subframe N and a subframe N+1/2 of equal durations. Likewise, frame N+1 is divided into a subframe N+1 and a subframe N+3/2. The images previously displayed during frames N and N+1 are henceforth displayed during subframes N and N+1 and the motion-compensated intermediate images are displayed during subframes N+1/2 and N+3/2. These images being motion compensated, the transition is therefore reduced.

A known solution for correcting the defects engendered by the high response time of the cells of the panel consists in using a so-called “overdrive” technique. According to this technique, to pass from a starting grey level ND to a target grey level NC, a voltage corresponding to an intercalary level NI which is higher or lower than the target level NC depending on whether the starting level ND of the pixel considered is respectively lower or higher than the target level NC is applied to the cell, before applying a voltage corresponding to the target level NC to it. This technique is illustrated by FIG. 4. This figure represents the voltage levels applied to the cell in order to reach a target level NC from a starting level ND as a function of time. In this example, the target level NC is higher than the starting level ND. In the absence of “overdrive”, a voltage level V_{ND} is applied to the cell during frame N and a voltage level V_{NC} is applied to it during frame N+1. The overdrive technique consists in applying a voltage level V_{NI}, higher than the voltage level V_{NC} in the present case, to the cell at the end of frame N or at the beginning of frame N+1 so that the cell reaches the target grey level NC more quickly. This voltage level V_{NI} is applied for a duration T1. This level is dependent on the discrepancy between the levels ND and NC. The greater this discrepancy, the higher the voltage level V_{NI} when NC>ND and the lower this voltage level when NC<ND.

The chain dotted curve represents the response of the cell in the absence of intercalary level NI. The target level NC is then reached only after a period of duration T2. In the presence of this intercalary level, the target level is reached after a period of duration T1 which is much lower than T2. This gain is shown in FIG. 4 by the dashed curve.

The implementation of this technique is improved by doubling the image display frequency. To do this, the display frame of an image is divided into two subframes. During the first subframe, a voltage corresponding to the intercalary level NI is applied to the cell and, during the second subframe, a voltage corresponding to the target level NC is applied. This technique is however inoperative for correcting the defects engendered by the mode of display.

A simple combination of these two techniques could be envisaged for correcting the “blurring effect” defects in a global manner. This simple combination would however require at the minimum quadrupling the image frequency, namely doubling the image frequency a first time so as to generate motion-compensated intermediate images, then doubling it a second time to apply the overdrive technique. This quadrupling of the image display frequency forces the panel to work four times faster and to address its cells four times more quickly, this not always being achievable.

### SUMMARY OF THE INVENTION

According to the invention, it is proposed that these two techniques be combined in a particular manner without having to quadruple the image frequency.

The present invention relates to a method of processing a video image sequence in a liquid crystal display panel comprising a plurality of cells each intended for displaying an image pixel, characterized in that it comprises the following steps:

for each group of m consecutive images of the sequence, m being greater or equal to 2, generating at least one motion-compensated image in order to obtain a group of n consecutive images, with n>m, and replacing into the sequence said group of m consecutive images by said group of n consecutive images,

for each pixel having in a current image of the new sequence a current grey level and in the next image of the sequence a target grey level different from said current grey level, calculating an intercalary grey level which is higher or lower than said target grey level depending on whether said target grey level is respectively higher or lower than the current grey level of said pixel,

replacing, in the current image, the current grey level of the pixels having in the next image a grey level different from the current grey level with said calculated intercalary level.

According to a particular embodiment, a single intermediate image is generated for each pair of consecutive images of the image sequence to be processed. The intercalary grey level of a pixel is determined in such a way that the grey level actually displayed by the cell intended to display said pixel is equal, on completion of the display frame of the current image, to the target grey level.

According to another embodiment, the generated motion-compensated images replace some images of said group of m consecutive images. For example, two motion-compensated images are generated and replace one of the two consecutive images.

The invention also relates to a device implementing the abovementioned method. It comprises:

a motion estimator and an interpolation block for generating motion-compensated images and putting them into the image sequence to be displayed,

a calculation block for calculating, for each pixel having in a current image of the sequence a current grey level and in the next image of the sequence a target grey level different from said current grey level, an intercalary grey level which is higher or lower than said target grey level depending on whether said target grey level is respectively higher or lower than the current grey level of said pixel, and for replacing, in the current image, the current grey level of the pixels having a target grey level different from the current grey level with said calculated intercalary level.

The invention also relates to a liquid crystal display panel intended for displaying a video image sequence, comprising a matrix of cells each intended to display an image pixel, a control circuit for said matrix of cells, and a device as defined above for processing the video image sequence received by the panel and for supplying the processed sequence to said control circuit for the matrix of cells.

### BRIEF DESCRIPTION OF THE DRAWINGS

The invention will be better understood and other features and advantages will become apparent on reading the description which follows, the description making reference to the appended drawings in which:

FIGS. 1A to 1C, already described, illustrate the display defects engendered by the response time and the mode of display of liquid crystal panels;

FIGS. 2A to 2C, already described, illustrate; the display defects related exclusively to the mode of display of liquid crystal panels;

FIGS. 3A to 3C, already described, illustrate a known solution intended for correcting the display defects engendered by the mode of display of liquid crystal panels;

FIG. 4, already described, the known overdrive technique for decreasing the response time of liquid crystal cells;

FIGS. 5A to 5C show the voltage levels applied to a cell changing level progressively over four images respectively in the case of a conventional display, in the case of a doubling of the image frequency with overdrive, in the case of a doubling of the image frequency with motion compensation;

FIG. 5D, to be compared with FIGS. 5A to 5C, shows the voltage levels applied to this same cell according to the method of the invention; and

FIG. 6 is the diagram of a device implementing the method of the invention.

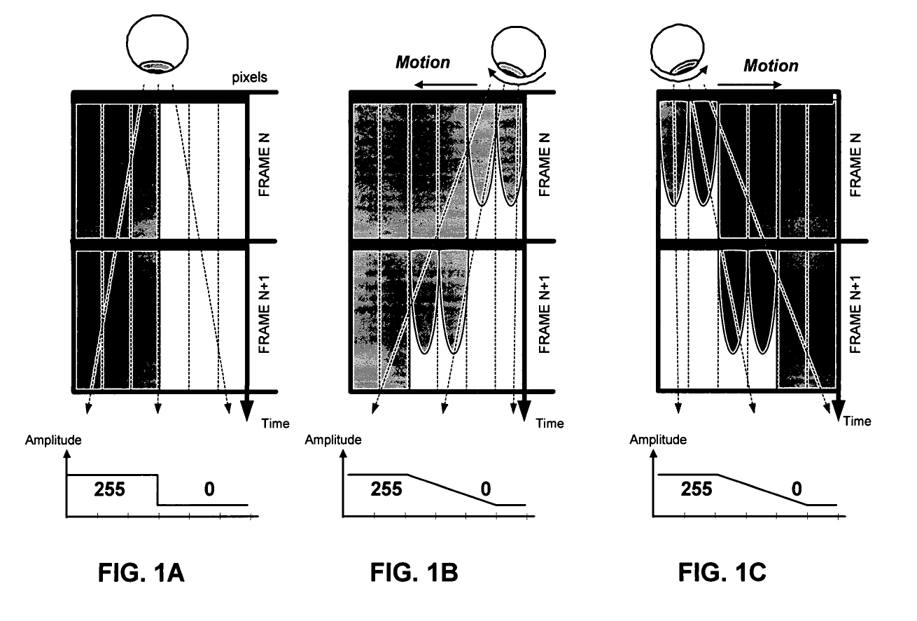

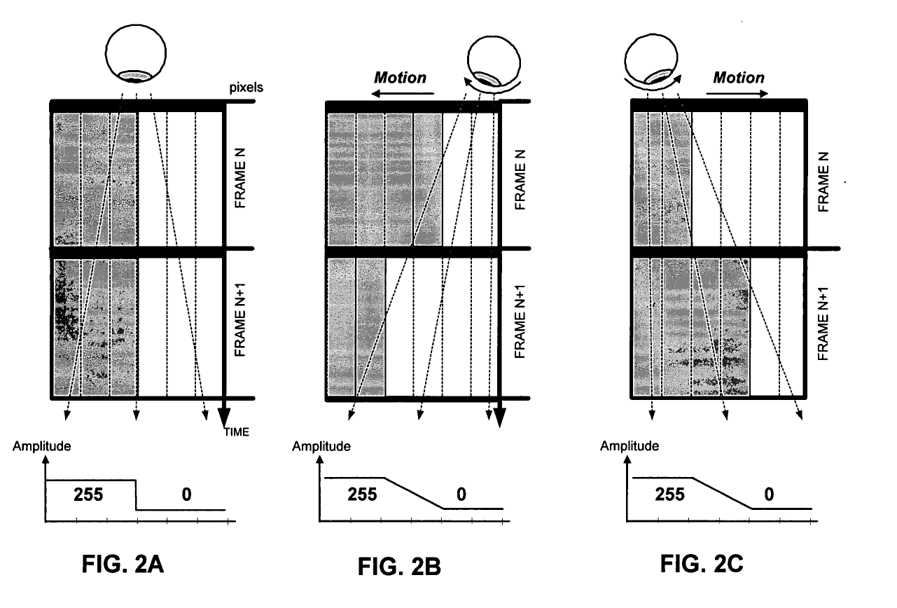

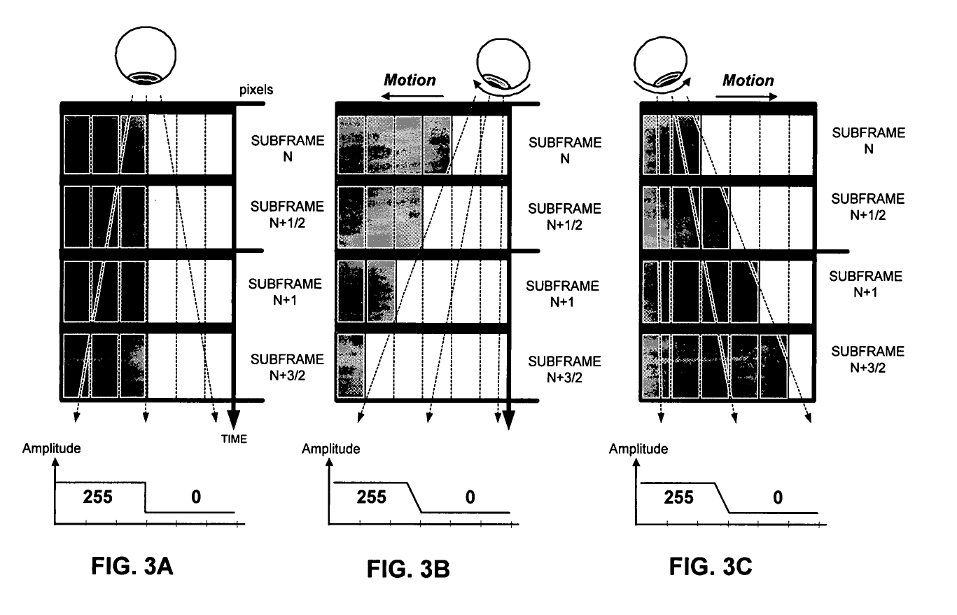

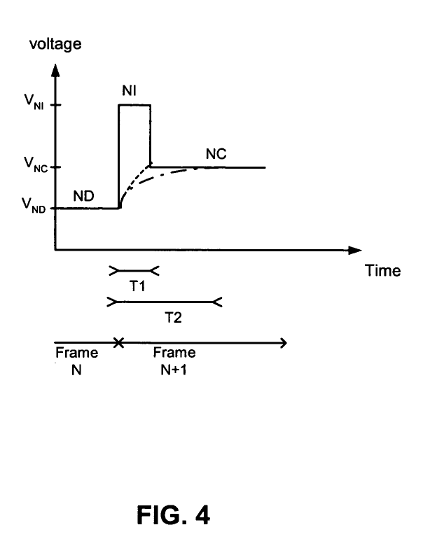

### DESCRIPTION OF EMBODIMENTS

According to the invention, the technique of increasing the image frequency with motion compensation and the overdrive technique are combined according to a particular process.

The method of the invention will be first described in the case of a doubling of the image frequency of the input video signal.

The method of display in accordance with the invention comprises the following steps E1 to E3:
(E1): generating, for each pair of consecutive images of the image sequence to be displayed, at least one motion-compensated intermediate image; the intermediate image or images generated are introduced into the sequence between the images of the image pair considered; this step requires the use of a motion estimator responsible for calculating a motion vector for each pixel of each image and of an interpolation circuit responsible for generating an intermediate image on the basis of the motion vectors and the grey levels of the pixels of one of the images of the image pair considered and for introducing it into the image sequence;
(E2) for each pixel having a current grey level ND in a current image of the sequence thus completed and a target grey level NC in the next image of the sequence, determining, if said levels ND and NC are different, an intercalary grey level corresponding to the grey level NI defined for the implementation of the overdrive technique, as indicated previously, this grey level is higher or lower than said target grey level NC depending on whether said target grey level is respectively higher or lower than the current grey level ND of said pixel; formulae for calculating this intercalary level are proposed further on in the description;
(E3) replacing, in the current image, the current grey level ND of the pixels having a target grey level NC different from the current grey level in the next image with the intercalary grey level NI.

Thus, according to the invention, during a transition between a grey level ND and a grey level NC, only the intercalary grey level NI is displayed so as not to have to double the image frequency.

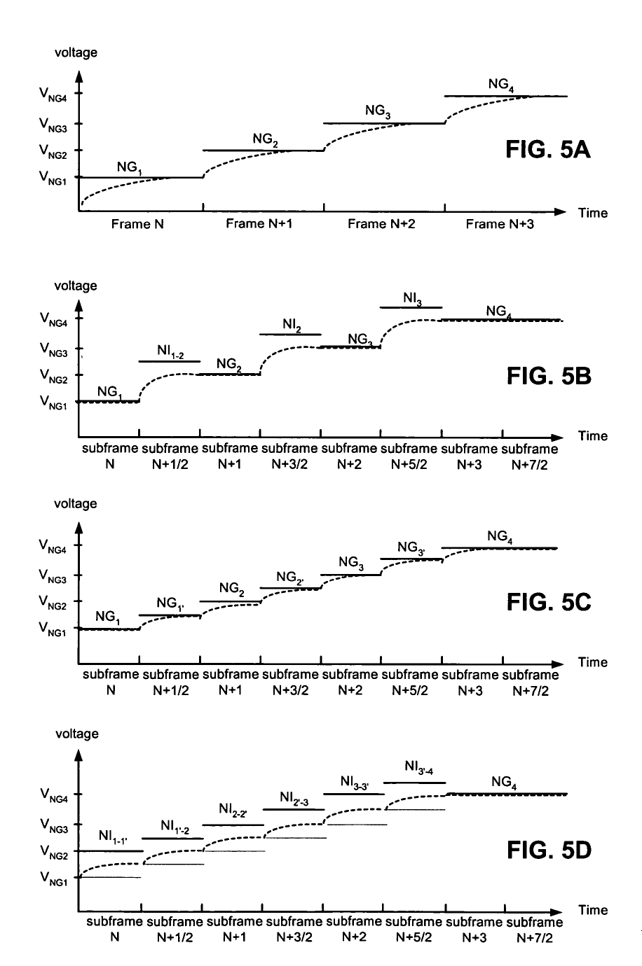

The method of the invention is illustrated hereinbelow by FIG. 5D to be compared with FIGS. 5A, 5B and 5C respectively illustrating a conventional display without modification of the image frequency, a display with “overdrive” and a display with insertion of motion-compensated intermediate images.

For these figures, we consider a pixel taking in succession the grey level values NG₁, NG₂, NG₃ and NG₄ with NG₁<NG₂<NG₃<NG₄, for respectively 4 consecutive frames N, N+1, N+2 and N+3 of duration T.

The conventional method of display, illustrated by FIG. 5A, consists in applying to the cell responsible for displaying said pixel, a voltage corresponding to the level NG₁, during frame N, then a voltage corresponding to the level NG₂ during frame N+1, then a voltage corresponding to the level NG₃ during frame N+2 and finally a voltage corresponding to the level NG4 during frame N+3. Given the response time of the cell, the actual grey level displayed by the cell at the beginning of the frames is lower than the desired grey level. This defect is illustrated in FIG. 5A by the dashed curve.

The application of the overdrive technique to this sequence consists in doubling the image frequency and in displaying, during the transition between a starting level ND and a target level NC, an intercalary voltage level NI during an intermediate frame, as illustrated in FIG. 5B. This intercalary level NI is taken to be higher or lower than the target level NC depending on whether the starting level ND is respectively lower or higher than the level NC. In FIG. 5B, intercalary levels NI₁₋₂, NI₂₋₃, NI₃₋₄ are therefore applied to the cell respectively for subframes N+1/2, N+3/2 and N+5/2 intercalated between subframes N, N+1, N+2 and N+3. The grey level actually displayed by the cell is represented by the dashed curve in the figure. As may be seen, this technique makes it possible to correct the defects related to the response time of the cells but it does not make it possible to correct the defects related to the mode of display.

The application of the technique consisting in generating motion-compensated intermediate images with doubling of the image frequency is illustrated in FIG. 5C. According to this technique, intermediate levels NG_{1′}, NG_{2′} and NG_{3′} are generated and they are applied during subframes N+1/2, N+3/2 and N+5/2. In FIG. 5C, the levels NG_{1′}, NG_{2′} and NG_{3′} are normally such that:
NG₁<NG_{1′}<NG₂
NG₂<NG_{2′}<NG₃
NG₃<NG_{3′}<NG₄
The images displayed during subframes N+1/2, N+3/2 and N+5/2 are moreover motion compensated. The dashed curve represents the grey level actually displayed by the cell.

The method of the invention is illustrated in FIG. 5D. This method consists in calculating, for each grey level transition of the method of FIG. 5C, an intercalary level NI in accordance with the overdrive technique and in displaying it during the subframe reserved for the display of the starting level ND of the transition. Thus, for the transition NG₁−NG_{1′}, we calculate an intercalary level NI1-1′ and we display it during subframe N. We do the same for the transition NG_{1′}-NG₂, NG₂-NG_{2′}, NG_{2′}-NG₃, NG₃-NG_{3′} and NG_{3′}-NG₄. The calculated intercalary levels NI_{1′-2}, NI_{2-2′}, NI_{2′-3}, NI_{3-3′} and NI_{3′-4} are displayed respectively during subframes N+1/2, N+1, N+3/2, N+2 and N+5/2.

The intercalary level NI between a starting level ND and a target level NC is for example calculated in the following manner:

$$NI = \frac{3}{2} NC - \frac{1}{2} ND$$

We therefore have:

$$\begin{matrix}{NI}_{1 - {1}^{′}} = \frac{3}{2} {NG}_{{1}^{′}} - \frac{1}{2} {NG}_{1} \\ {NI}_{{1}^{′} - 2} = \frac{3}{2} {NG}_{2} - \frac{1}{2} {NG}_{{1}^{′}} \\ {NI}_{2 - {2}^{′}} = \frac{3}{2} {NG}_{{2}^{′}} - \frac{1}{2} {NG}_{2} \\ {NI}_{{2}^{′} - 3} = \frac{3}{2} {NG}_{3} - \frac{1}{2} {NG}_{{2}^{′}} \\ {NI}_{3 - {3}^{′}} = \frac{3}{2} {NG}_{{3}^{′}} - \frac{1}{2} {NG}_{3} \\ {NI}_{{3}^{′} - 4} = \frac{3}{2} {NG}_{4} - \frac{1}{2} {NG}_{{3}^{′}}\end{matrix}$$

The dashed curve in FIG. 5D shows the grey level actually displayed by the cell during subframes N, N+1/2, N+1, N+3/2, N+2, N+5/2, N+3 and N+7/2. As may be seen, this method makes it possible to reduce the defects related to the high response time of the cell. Furthermore, since the intermediate images are motion compensated, they also make it possible to reduce the defects related to the mode of display.

In this embodiment above described, the image frequency is doubled.

In a variant, the method of the invention can be applied to a case where the image frequency is just increased and not necessarily doubled. For example, the image frequency can increase from 50 Hz to 75 Hz. In that case, for each group of two consecutive images, two motion-compensated images are generated and replace one of the two consecutive images.

More generally, the generated motion-compensated images can be introduced between images of the group of consecutive images of the input video signal and/or replace some images of said group.

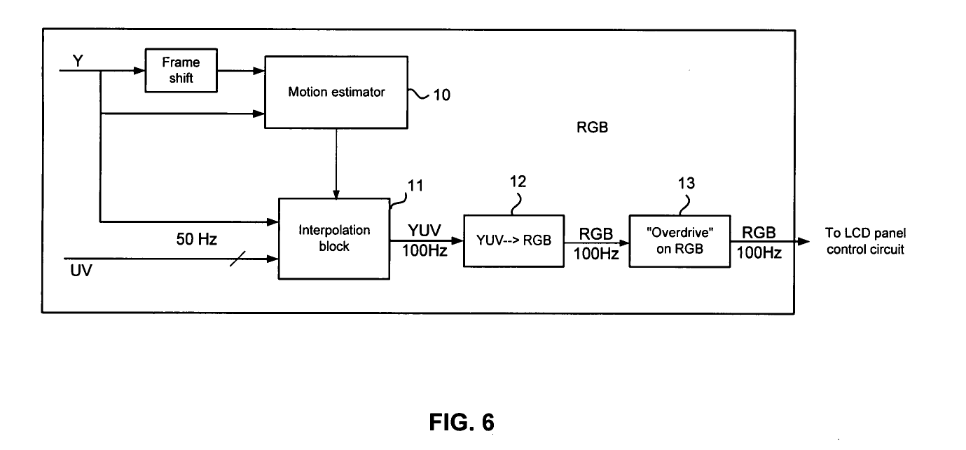

A device implementing the method of the invention is shown in FIG. 6. This device receives a composite video signal comprising a luminance signal Y and chrominance signals UV. The frequency of the images of the video signal is for example equal to 50 Hz. The luminance signal Y is supplied to a motion estimator 10 comprising two inputs. This signal is supplied, on one of the inputs, with a shift of a frame and, on the other input, with no shift. The motion estimator 10 is responsible for calculating a motion vector for each pixel of each of the images, this motion vector being representative of the motion between said image and the next image in the image sequence to be displayed. If the motion estimator 10 does not detect any motion between the two images for the pixel considered, the motion vector associated with this image pixel is zero. The luminance signal Y and the chrominance signals UV are moreover supplied to an interpolation block 11 also receiving the motion vectors calculated by the motion estimator 10. This block accomplishes step E1 of the method of the invention. For this purpose, it calculates, on the basis of the motion vectors and of the video signal YUV, motion-compensated intermediate images. The signal supplied to the output of this block is a 100 Hz signal comprising the images of the starting video signal and intermediate images. This YUV signal is then converted by a converter 12 into an RGB signal (comprising a component R for the red, a component G for the green and a component B for the blue) utilizable by the control circuit of the liquid crystal panel. The resulting RGB signal is then processed by a block 13 responsible for implementing steps E2 and E3 of the method of the invention. This block calculates an intercalary level for each pixel changing level in the next image and, for these pixels, replaces the current grey level with the calculated intercalary grey level. The images thus modified are then supplied to a control circuit 14 of the liquid crystal display panel which displays the images supplied by the block 13.

It is possible to envisage generating, for each pair of images of the video signal, several intermediate images in the interpolation block 11. However, the benefit of the method of the invention is less since the control circuit 14 of the display panel must then display with a display frequency of higher than 100 Hz.

1. Method of processing a video image sequence in a liquid crystal display panel comprising a plurality of cells each intended for displaying an image pixel, wherein it comprises the following steps:
for each group of m consecutive images of the sequence, m being greater or equal to 2, generating at least one motion-compensated image in order to obtain a group of n consecutive images, with n>m, and replacing into the sequence said group of m consecutive images by said group of n consecutive images,
for each pixel having in a current image of the new sequence a current grey level and in the next image of the sequence a target grey level different from said current grey level, calculating an intercalary grey level which is higher or lower than said target grey level depending on whether said target grey level is respectively higher or lower than the current grey level of said pixel,
replacing, in the current image, the current grey level of the pixels having in the next image a grey level different from the current grey level with said calculated intercalary level.

2. Method according to claim 1, wherein the generated motion-compensated images are introduced between images of said group of m consecutive images and/or replace images of said group of m consecutive images.

3. Method according to claim 2, wherein, for each group of two consecutive images, one motion-compensated image is generated and introduced between the two images of said group.

4. Method according to claim 2, wherein for each group of two consecutive images, two motion-compensated images are generated and replace one of the two consecutive images.

5. Method according to claim 1, wherein the intercalary grey level of a pixel is determined in such a way that the grey level actually displayed by the cell intended to display said pixel is equal, on completion of the display frame of the current image, to the target grey level.

6. Method according to of claim 5, wherein the intercalary grey level NI of a pixel passing from a current grey level ND to a target grey level NC is calculated through the following formula:
$$NI = \frac{3}{2} NC - \frac{1}{2} ND$$

7. Device implementing the method according to claim 1, wherein it comprises:
a motion estimator and an interpolation block for generating motion-compensated intermediate images and putting them into the image sequence to be displayed,
a calculation block for calculating, for each pixel having in a current image of the sequence a current grey level and in the next image of the sequence a target grey level different from said current grey level, an intercalary grey level which is higher or lower than said target grey level depending on whether said target grey level is respectively higher or lower than the current grey level of said pixel, and for replacing, in the current image, the current grey level of the pixels having a target grey level different from the current grey level with said calculated intercalary level.

8. Liquid crystal display panel intended for displaying a video image sequence, comprising a matrix of cells each intended to display an image pixel and a control circuit for said matrix of cells, wherein it furthermore comprises a device according to claim 7 for processing the video image sequence received by the panel and for supplying the processed sequence to said control circuit for the matrix of cells.

9. A method of processing a sequence of images comprising the steps of:
generating at least one motion compensated image for at least two consecutive images of a first sequence of images;
including at least one motion compensated image in said first sequence to yield a second sequence of images;
comparing a grey level of least one pixel of a first image of said second sequence with a grey level of a corresponding pixel of a subsequent image of said second sequence;
adjusting said grey level of said at least one pixel of said first image based upon the results of the comparing step.

10. The method of claim 9, wherein said including step is carried out by replacing at least one image of said first image sequence with said motion compensated image.

11. The method of claim 9 wherein a motion compensated image is generated for, and inserted in, each successive pair of images of said first image sequence.

12. The method of claim 9 wherein two motion compensated images are generated for each successive pair of images of said first image sequence, and wherein, for each successive pair of images, one image of said pair is replaced by one of said motion compensated images and the other motion compensation image is added to the resulting pair to form a triplet of images.

13. The method according to claim 9 wherein the adjusting step includes a step of determining an intercalary grey level NI of a pixel and adjusting the current grey level ND of said pixel to a target grey level NC.

14. The method according to of claim 13, wherein the intercalary grey level NI is determined by the relationship:
$$NI = \frac{3}{2} NC - \frac{1}{2} ND$$

15. A video image processing device comprising:
a motion estimator;
an interpolator for generating motion-compensated intermediate images and putting them into an image sequence to be displayed; and,
a calculator for calculating, for each pixel having in a current image of said sequence a current grey level and in the next image of the sequence a target grey level different from said current grey level, an intercalary grey level which is higher or lower than said target grey level depending on whether said target grey level is respectively higher or lower than the current grey level of said pixel, and for replacing, in the current image, the current grey level of the pixels having a target grey level different from the current grey level with said calculated intercalary level.

16. The device of claim 15 further comprising a Liquid crystal display for displaying said video image sequence.

17. The device of claim 16 wherein said liquid crystal display comprises a matrix of cells each intended to display an image pixel.

18. The device of claim 17 further including a control circuit for said matrix of cells, said control circuit for processing said video image sequence and for supplying the processed sequence to said control circuit for the matrix of cells.
